(19) United States
(12) Patent Application Publication
(10) Pub. No.: US 2008/0254245 A1
(43) Pub. Date: Oct. 16, 2008

(54) CONTAINER CONSTRUCTIONS

(75) Inventors: Mihaela Penescu, Decatur, GA (US); Jesse Wayne Barron, Powder Springs, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Consolidated Container Company LP

(21) Appl. No.: 12/101,538

(22) Filed: Apr. 11, 2008

Related U.S. Application Data
(60) Provisional application No. 60/911,732, filed on Apr. 13, 2007.

(51) Int. Cl. B32B 27/08; B32B 27/30; B32B 7/12; B32B 1/00; B32B 27/32; B32B 27/34

(52) U.S. Cl. 428/36.7; 428/35.7; 428/36.6

(57) ABSTRACT

A container, according to various embodiments of the invention, includes a co-extruded, blow molded wall that comprises: (1) a first, inner surface layer, (2) a second, interior layer; and (3) a third layer. In one embodiment, the inner surface layer comprises an extrusion blow-molding-capable grade of PET; the second, interior layer comprises adhesive; and the third layer comprises a polyolefin and the regrind material from one or more containers similar to the blow molded container. In various embodiments, the third layer is an outer surface layer of the blow molded wall. Alternatively, the container may further comprise a fourth (e.g., exterior surface) layer that comprises a polyolefin. In other embodiments, the inner surface layer comprises an extrusion blow-molding-capable grade of PET; the second, interior layer comprises a barrier material, such as polyamide resin, EVOH, or a compatible oxygen scavenger; and the third layer comprises an extrusion blow-molding-capable grade of PET.

### CROSS-REFERENCE TO RELATED APPLICATIONS

This application claims the benefit of U.S. Provisional Application Ser. No. 60/911,732, filed Apr. 13, 2007, the contents of which are incorporated herein by reference in their entirety.

### BACKGROUND OF THE INVENTION

Monolayer Polyethylene terephthalate (PET) containers are known to have better clarity, gloss, and oxygen and scalping barrier properties compared to containers made from monolayer polyolefins such as High Density Polyethylene (HDPE) and Polypropylene (PP). In many cases, such as when the container is used to store food products such as orange juice, it is desirable for the container to have barrier properties that are conducive to, for example, maintaining the original flavor and nutrient content of the food product (e.g. preventing flavor scalping), to prevent migration of odors into and out of the container, and to prevent the product from spoiling. Many PET containers are made in an injection stretch blow process that limits bottle design and performance (e.g., no integrated handle) compared to the extrusion blow mold process typically used for polyolefins. Currently, extrusion blow molding-grade polyethylene terephthalates (EPET) are known to produce monolayer plastic containers having a handle, a desirable clear and glossy appearance, and desirable barrier properties. Many polyolefin container applications do not require clarity, but would still benefit from the improved barrier and gloss properties of PET in a more cost effective package.

For container applications where clarity is important and a high oxygen barrier is required, it is known to produce co-extruded layers of PET and a high barrier polymer (e.g. polyamide resins, or EVOH) in the injection stretch blow molding process. In this process, adhesive layers are often needed to provide sufficient bonding strength between the wall layers. Many of these applications would benefit from more design and process flexibility.

### SUMMARY OF VARIOUS EMBODIMENTS OF THE INVENTION

A blow molded container according to particular embodiments of the invention include a co-extruded wall that comprises: (1) a first, inner surface layer comprising an extrusion blow-molding-capable grade of PET, such as: (a) copolysters of polyethylene terephthalates (EPET) (e.g., EB062 sold by Eastman Chemical Company) and (b) glycol-modified polyethylene terephthalates (PETG); (2) a second, interior layer comprising adhesive polymer; and (3) a third layer comprising a polyolefin and part generated regrind material from one or more containers having a composition that is similar to that of the blow molded container. In particular embodiments, the second layer is disposed between the first and third layers and is adapted to bond the first layer to the third layer. In various embodiments, the third layer is an outer surface layer of the co-extruded wall.

In a particular embodiment, the blow molded container further includes a fourth layer that comprises a polyolefin; and the second and third layers are disposed between the first and fourth layers. In various embodiments, the fourth layer is an exterior surface layer of the blow molded wall.

A blow molded container according to further embodiments of the invention include a wall comprising: (1) a first, inner surface layer comprising an extrusion blow-molding-capable grade of PET; (2) a second, interior layer comprising a barrier material selected from the group consisting of polyamide resins, ethylene vinyl alcohol polymers (EVOH), and PET-compatible oxygen scavengers; and (3) a third layer comprising an extrusion blow-molding-capable grade of PET. In particular embodiments, the second layer is disposed between the first and third layers. Also, in various embodiments, the third layer is an outer surface layer of the wall.

A blow molded container according to yet another embodiment of the invention includes a co-extruded wall that includes at least one layer comprising a blend of an extrusion blow-molding-capable grade of PET and one or more materials selected from a group consisting of polyamide resins, EVOH, and PET-compatible oxygen scavengers.

### BRIEF DESCRIPTION OF THE DRAWINGS

Having thus described the invention in general terms, reference will now be made to the accompanying drawings, which are not necessarily drawn to scale, and wherein:

FIG. 1 is a front, partial cross-sectional view of a plastic blow molded container according to one embodiment of the invention. This container serves as a representative example of many different styles and designs of containers relevant to various embodiments of the invention.

FIG. 2 is a cross sectional view of a container wall according to a particular embodiment of the invention. Such a wall may be the wall of a plastic blow molded container, such as the container of FIG. 1.

FIG. 3 is a cross sectional view of a container wall according to a particular embodiment of the invention. Such a wall may be the wall of a plastic blow molded container, such as the container of FIG. 1.

FIG. 4 is a cross sectional view of a container wall according to a particular embodiment of the invention. Such a wall may be the wall of a plastic blow molded container, such as the container of FIG. 1.

FIG. 5 is a cross sectional view of a container wall according to a particular embodiment of the invention. Such a wall may be the wall of a plastic blow molded container, such as the container of FIG. 1.

FIG. 6 is a cross sectional view of a container wall according to a particular embodiment of the invention. Such a wall may be the wall of a plastic blow molded container, such as the container of FIG. 1.

FIG. 7 is a cross sectional view of a container wall according to a particular embodiment of the invention. Such a wall may be the wall of a plastic blow molded container, such as the container of FIG. 1.

### DETAILED DESCRIPTION OF VARIOUS EMBODIMENTS OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

### Overview

Containers (e.g., bottles) according to various embodiments of the invention comprise a blow molded wall that defines the container's external dimensions and separates the container's contents from the exterior environment. In particular embodiments, the wall is made by co-extruding different polymers simultaneously during the extrusion blow molding process. In particular embodiments, such polymers may include at least one extrusion blow-molding-capable grade of PET, such as: (a) a copolyster of polyethylene terephthalates (EPET) (e.g., EB062 sold by Eastman Chemical Company); or (b) a glycol-modified polyethylene terephthalate (PETG). This extrusion blow-molding-capable grade of PET may be in separate layers and/or blends with at least one other polymer material.

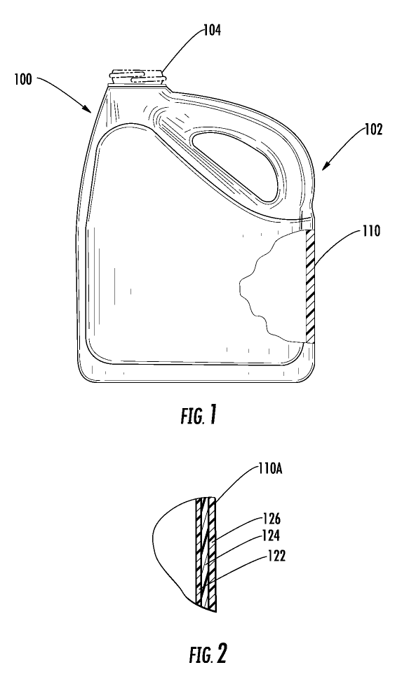

Various exemplary embodiments of the invention are discussed in greater detail below in regard to FIGS. 1-6. FIG. 1 is a front, partial cross-sectional view of an exemplary plastic blow molded container according to a particular embodiment of the invention. As may be understood from this figure, the container 100 includes a container body 102 and a finish 104.

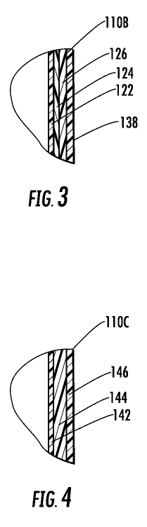

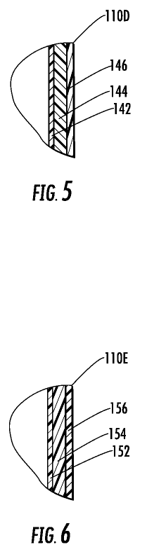

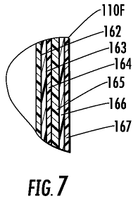

FIGS. 2-6 show close-up cross sectional views of various alternative embodiments of the container wall 110 shown in FIG. 1. For example: FIG. 2 shows a first alternative embodiment 110A of the container wall 110 of FIG. 1; FIG. 3 shows a second alternative embodiment 110B of the container wall 110 of FIG. 1; FIG. 4 shows a third alternative embodiment 110C of the container wall 110 of FIG. 1; FIG. 5 shows a fourth alternative embodiment 110D of the container wall 110 of FIG. 1; FIG. 6 shows a fifth alternative embodiment 110E of the container wall 110 of FIG. 1; and FIG. 7 shows a sixth alternative embodiment 110F of the container wall 110 of FIG. 1.

### Discussion of the Embodiments of FIGS. 2 and 3, and Other Related Embodiments

As may be understood from FIG. 2, a container according to various embodiments of the invention includes a container body having at least one co-extruded, blow molded wall 110A that comprises a first layer 122, a second layer 124, and a third layer 126. In the embodiment shown in FIG. 2, the first layer 122 is an inner surface layer of the container wall 110A and comprises (and, in various embodiments, consists of, and/or consists essentially of) an extrusion blow-molding-capable grade of PET. Examples of such extrusion blow-molding-capable grades of PET include products sold as PETG and Copolyester PET such as: Eastar Copolyester GN046 and Eastar Copolyester EBO62 sold by Eastman Chemical Company.

The first layer 122 may optionally comprise one or more additional additives. Suitable additives include additives compatible with PETs. For example, suitable additives may include, but are not limited to, oxygen scavenger additives such as cycloolefin polymers and copolymers and unsaturated polyolefins. Examples of suitable additives include those sold by BP Amoco Chemicals under the AMOSORB® name and iron oxide formulations such as those sold by Mitsubishi Gas Chemical Company under the AGELESS® name. According to one embodiment, the additives are suitable for and approved for use with foodstuffs.

In this embodiment, the second layer 124 is an interior layer (e.g., a “tie layer”) that comprises (and, in particular embodiments, consists of, and/or consists essentially of) an adhesive or tie-layer resin suitable for bonding extrusion blow-molding-capable grades of PET and polyolefins. This adhesive or tie-layer resin may comprise, for example, a maleic anhydride-modified polyolefin, such as maleic anhydride-modified polyethylenes (PE), including modified medium density polyethylenes (MDPE), low density polyethylenes (LDPE) and linear low density polyethylenes (LLDPE), and maleic anhydride-modified polypropylenes (PP). Commercially available suitable adhesives include those sold by Rohm & Haas under the TYMOR™ name, those sold by Equistar Chemicals under the PLEXAR® name including PLEXAR® PX 6002 and PLEXAR® PX 3236, and those sold by Mitsui Chemicals under the ADMER® name.

In the embodiment shown in FIG. 2, the container wall's third layer 126 comprises (and, in other particular embodiments, consists of, and/or consists essentially of) virgin polyolefin and/or regrind material from monolayer or multilayer polyolefin bottles. Preferably, regrind material comprises pre-consumer scrap and/or part generated flash from one or more containers that have a composition that is similar to (and preferably substantially the same as) that of the container itself (and/or one of the container's walls). For example, according to one embodiment, the container comprises a first layer 122 comprising an extrusion blow-molding-capable grade of PET, a second layer 124 comprising an adhesive comprising a maleic anhydride-modified polyolefin, and a third layer 126 comprising high density polyethylene (HDPE). According to another embodiment, the container comprises a first layer 122 comprising an extrusion blow-molding-capable grade of PET, a second layer 124 comprising a maleic anhydride-modified polyolefin, and a third layer 126 comprising regrind from the extrusion blow-molding-capable grade of PET/adhesive/HDPE composition. In a preferred embodiment, the regrind material comprises (and, in particular embodiments, consists of, and/or consists essentially of) flash material from one or more containers of the same type as the container. In some embodiments, the regrind material comprises (and, in particular embodiments, consists of, and/or consists essentially of) flash material from one or more containers that are produced at the same manufacturing facility as the container (e.g., containers produced on the same production line as the container).

The third layer 126 may also include an additional amount of a suitable adhesive. Suitable adhesives for the third layer 126 include the adhesives or tie-layer resins disclosed above comprising, for example, maleic anhydride-modified polyolefin. Where the third layer 126 includes regrind material, the regrind melt preferably includes a suitable adhesive, more preferably the same adhesive as was used in production of the material used as regrind. Where the third layer 126 includes adhesive and regrind, the adhesive is preferably added to the regrind melt prior to extrusion. The amount of adhesive added to the regrind melt may vary and may be adjusted to optimize a property of the third layer, such as brittleness, adhesion, or gloss. In particular embodiments, the amount of adhesive added is suitable to prevent brittleness and breakage of the container during the extrusion process and normal use of the container. The amount of adhesive added to the regrind melt is preferably about 0.5% to about 10% by weight, more preferably about 1% to about 5%, most preferably 3% to 5%, based on the weight of the regrind material.

In particular embodiments, the third layer 126 may be an outer surface layer of the container wall 110A. However, in other embodiments, the container may include other layers that are closer to the container's exterior than the third layer 126. For example, in one embodiment, the container wall includes a fourth layer adjacent the outer surface of the third layer that serves as the outer surface layer of the container wall.

As may be understood from FIG. 2, in various embodiments, an outer side of the first layer 122 engages an inner side of the second layer 124, and an inner side of the third layer 126 engages an outer side of the second layer 124.

As may be understood from FIG. 3, in particular embodiments of the invention, the container wall 110B includes the first, second, and third layers 122, 124, 126 described above, and further includes an additional fourth layer 138, which may be an exterior layer of the container wall 110B. However, in other embodiments, the container may include other layers that are closer to the container's exterior than the fourth layer 138. For example, in one embodiment, the container wall 110B includes a fifth layer (not shown) adjacent the outer surface of the fourth layer 138 that serves as the outer surface layer of the container wall.

In various embodiments, the fourth layer 138 comprises (and, in particular embodiments, consists of, and/or consists essentially of) one or more polyolefins. In particular embodiments, these one or more polyolefins may be, for example, selected from a group consisting of polyethylenes and polypropylene. In particular embodiments, these one or more polyolefins may be selected from a group consisting of HDPE and polypropylene. However, in other embodiments, other suitable polyolefins may be used.

As may be understood from FIG. 3, in the embodiment shown in this figure, the second and third layers 124, 126 are disposed between the first and fourth layers 122, 138. As may also be understood from this figure, in this embodiment, an outer side of the first layer 122 engages an inner side of the second layer 124, an inner side of the third layer 126 engages an outer side of the second layer 124, and an inner side of the fourth layer 138 engages an outer side of the third layer 126.

The thicknesses and relative weight of the first layer 122, second layer 124, third layer 126, optional fourth layer 138, and other optional additional layers may vary based on the desired properties of the container, the relative costs of materials, capabilities of process equipment, and other variables. According to one embodiment, the first layer 122 comprises about 2% to about 10% by weight, more preferably about 2% to about 5%, and most preferably about 5%, based on the total weight of the extruded wall 110B of the container. According to another embodiment, the first layer 122 comprises about 2% to about 20% by weight, based on the total extruded wall weight of the container. According to another embodiment, the first layer 122 comprises more than 10% by weight of the container. According to one embodiment, the second layer 124 comprises about 0.2 to about 10%, more preferably about 0.5 to about 3%, based on the total weight of the extruded wall 110B of the container.

In particular embodiments, the container wall 110 is transparent. In other embodiments, the container wall 110 is substantially clear. In particular embodiments, the amount of flavor scalping is reduced relative to a similar HDPE container. In particular embodiments, the amount of gas transmission, including oxygen transmission, is reduced relative to a similar monolayer HDPE container.

### Discussion of the Embodiments of FIGS. 4 and 5, and Other Related Embodiments

In the embodiment shown in FIG. 4, the first layer 142 of the container wall 110C is an inner surface layer of the container wall 110C and comprises (and, in various embodiments, consists of, and/or consists essentially of) an extrusion blow-molding-capable grade of PET. Suitable extrusion blow-molding-capable grades of PET's include those provided for the embodiments of FIGS. 2 and 3 above. In this embodiment, the second layer 144 is an interior layer that comprises (and, in particular embodiments, consists of, and/or consists essentially of) polyamide resin. Suitable polyamide resins include nylon 6, nylon 66, Nylon-MXD6, and nylon-clay nanocomposites, including such commercially available products from EMS-Grivory, from Honeywell under the AEGIS™ name, and from Mitsubishi Gas Chemical.

In particular embodiments, the container wall's third layer 146 comprises (and, in particular embodiments, consists of, and/or consists essentially of) an extrusion blow-molding-capable grade of PET. In particular embodiments, the third layer 146 may be an outer surface layer of the container wall 110C. However, in other embodiments, the container may include other layers that are closer to the container's exterior than the third layer 146. For example, in one embodiment, the container wall 110C includes a fourth layer (not shown) adjacent the outer surface of the third layer 146 that serves as the outer surface layer of the container wall 110C.

As may be understood from FIG. 4, in various embodiments, an outer side of the first layer 142 engages an inner side of the second layer 144, and an inner side of the third layer 146 engages an outer side of the second layer 144.

In alternative embodiments of the container wall discussed above in regard to FIG. 4, the container wall's second layer 144 (or any of the container wall's other layers) may have a different composition than the composition described above in regard to FIG. 4. For example, in particular embodiments such as the embodiment of the container wall 110D shown in FIG. 5, the container wall's second layer 144 comprises (and, in particular embodiments, consists of, and/or consists essentially of) at least one ethylene vinyl alcohol copolymer (EVOH). Commercially available EVOH's include those available from Kurarary Co. and Eval Company of America under the EVAL® name and those available from Soarus under the SOARNOL® name.

In the embodiment shown in FIG. 5, the structure and composition of the other aspects of the container wall (e.g., the structure and composition of the first and third layers 142, 146) are the same as those described above with regard to the embodiment discussed above in regard to FIG. 4. In alternative embodiments, the second layer 144 comprises at least one PET-compatible oxygen scavenger. As used herein, PET-compatible refers to materials that adhere to or may be blended with PET and an extrusion blow-molding-capable grade of PET without requiring an additional adhesive layer. Suitable PET-compatible oxygen scavengers include cycloolefin polymers and copolymers and unsaturated polyolefins, including those commercially available from BP Amoco Chemicals under the AMOSORB® name. It should be understood that, in other embodiments, the structure and composition of the other aspects of the container wall (e.g., the structure and composition of the first and third layers 142, 146) may be different than those described above with regard to the embodiment discussed above in regard to FIG. 4.

In particular embodiments, the container wall 110 is transparent. In other embodiments, the container wall 110 is substantially clear. In particular embodiments, the amount of flavor scalping is reduced relative to a similar HDPE container. In particular embodiments, the amount of gas transmission, including oxygen transmission, is reduced relative to a similar HDPE container. In particular embodiments, the amount of gas transmission, including oxygen transmission, is reduced relative to a similar monolayer PET container.

### Discussion of the Embodiment of FIG. 6, and Other Related Embodiments

In various embodiments of the invention, a polymer blend is used as at least one layer in a co-extruded multi-layer container (e.g., bottle) wall structure. In particular embodiments, the wall structure consists of (or consists essentially of) this polymer blend. In particular embodiments, the polymer blend comprises (and, in particular embodiments, consists of, and/or consists essentially of) an extrusion blow-molding-capable grade of PET and one or more materials selected from a group consisting of: polyamide resin, EVOH, and PET-compatible oxygen scavengers. In particular embodiments, the polymer blend may comprise regrind from one or more of the embodiments as described above for FIG. 4 or 5. For example, in one embodiment, the polymer blend comprises the regrind from a multilayer extrusion blow-molding-capable grade of PET /EVOH/extrusion blow-molding-capable grade of PET extrusion process.

In various embodiments, the polymer blend may be used as a replacement for an extrusion blow-molding-capable grade of PET in any of the embodiments described herein. For example, according to one embodiment, shown in FIG. 6, that is similar to that described above in relation to FIG. 2, the container comprises a first layer 152 comprising a blend of an extrusion blow-molding-capable grade of PET and polyamide resin, a second layer 154 comprising an adhesive, and a third layer 156 comprising a polyolefin and bottle regrind. The polymer blend may provide improved barrier properties over a virgin extrusion blow-molding-capable grade of PET.

In other embodiments, a blend of an extrusion blow-molding-capable grade of PET, EVOH and optional adhesives may be used as a replacement or partial replacement for EVOH in known multilayer processes. For example, according to one embodiment, the container may comprise a first layer comprising polypropylene, a second layer comprising a suitable adhesive, a third layer comprising a blend of an extrusion blow-molding-capable grade of PET and EVOH, a fourth layer comprising a suitable adhesive, and a fifth layer comprising polypropylene. According to another embodiment, the container may comprise a first layer comprising HDPE, a second layer comprising a suitable adhesive, a third layer comprising a blend of an extrusion blow-molding-capable grade of PET and EVOH, a fourth layer comprising a suitable adhesive, and a fifth layer comprising HDPE. In various embodiments of the invention described above, the first through fifth layers are sequential (or substantially sequential layers) with the first layer being the closest of the layers to the container's interior and the fifth layer being the closest of the layers to the container's exterior. Accordingly, in such embodiments, the second layer would be the second closest of the layers to the container's interior, the third layer would be the third closest of the layers to the container's interior, and the fourth layer would be the fourth closest of the layers to the container's interior.

In a further embodiment shown in FIG. 7, the container comprises a first layer 162 that comprises a polyolefin, a second layer 163 that comprises regrind material (e.g., regrind material from one or more containers having a composition that is similar to that of the container), a third layer 164 that comprises an adhesive, a fourth layer 165 that comprises a blend of an extrusion blow-molding-capable grade of PET, a fifth layer 166 that comprises an adhesive, and a sixth layer 167 that comprises a polyolefin. In various embodiments of the invention, the first through sixth layers 162-167 are sequential (or substantially sequential layers) with the first layer 162 being the closest of the layers to the container's interior and the sixth layer being the closest of the layers to the container's exterior.

Exemplary embodiments of the containers described herein are typically made using an extrusion blow-molding process, such as that described in U.S. Pat. No. 4,846,359. In this process, molten thermoplastic material is extruded through an extrusion die head to form a substantially tubular parison. A mold is closed around the parison to pinch the parison's tail and form the bottom of the container. Pressurized air is then injected into the parison to expand it until it comes into contact with the mold's interior surface. After the formed container has cooled and solidified, the mold is opened and the finished container may be removed. The extruder or extruders used according to the invention may include, for example, any extruders suitable for multi-layer/coextruded processes, including shuttle, rotary wheel, and reciprocating-screw blow molding equipment.

### Advantages of Various Selected Embodiments of the Invention

Various embodiments of the invention may include one or more of the following advantages over prior art containers: (1) improved food product taste (due to a reduction in flavor scalping) compared to monolayer polyolefin containers; (2) improved product shelf life (which may be due, for example, to improved oxygen and/or chemical barrier characteristics); (3) improved clarity/gloss; (4) lower production cost than monolayer EPET bottles; and/or (5) improved container design flexibility compared to current PET bottles. It should be understood that particular embodiments of the invention may include advantageous characteristics other than those listed above and that some embodiments may include none of the above advantageous characteristics.

### CONCLUSION

Many modifications and other embodiments of the invention will come to mind to one skilled in the art to which this invention pertains having the benefit of the teachings presented in the foregoing descriptions and the associated drawings. Accordingly, it should be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

We claim:

1. A blow molded container having a co-extruded, blow molded wall, said wall comprising:
a first layer comprising an extrusion blow-molding-capable grade of PET, said first layer being an inner surface layer of said wall;
a second, interior layer, said second layer comprising adhesive; and
a third layer comprising: (A) a polyolefin, and (B) regrind material from one or more containers having a composition that is similar to that of said blow molded container; wherein:
said second layer is disposed between said first and third layers and is adapted to bond said first layer to said third layer.

2. The blow molded container of claim 1, wherein:
said third layer is an exterior surface layer of said wall.

3. The blow molded container of claim 1, wherein:
said first layer engages an inner side of said second layer;
said third layer engages an outer side of said second layer.

4. The blow molded container of claim 3, wherein:
said third layer is an exterior surface layer of said wall.

5. The blow molded container of claim 1, wherein said first layer consists essentially of an extrusion blow-molding-capable grade of PET.

6. The blow molded container of claim 5, wherein said third layer consists essentially of: (A) said polyolefin, and (B) said regrind material.

7. The blow molded container of claim 6, wherein said second layer consists essentially of said adhesive material.

8. The blow molded container of claim 1, wherein said third layer consists essentially of regrind material from one or more containers having a composition similar to that of said blow molded container.

9. The blow molded container of claim 1, wherein said second layer consists essentially of said adhesive material.

10. The blow molded container of claim 1, wherein:
said blow molded container further comprises a fourth layer that comprises a polyolefin; and
said second and third layers are disposed between said first and fourth layers.

11. The blow molded container of claim 10, wherein:
said fourth layer is an exterior surface layer of said wall.

12. The blow molded container of claim 10, wherein said polyolefin is selected from a group consisting of HDPE and Polypropylene.

13. The blow molded container of claim 12, wherein:
said fourth layer is an exterior surface layer of said wall.

14. The blow molded container of claim 13, wherein:
said first layer engages an inner side of said second layer; and
said third layer engages an outer side of said second layer and an inner side of said fourth layer.

15. The blow molded container of claim 1, wherein:
said container comprises a body portion that consists essentially of said first, second, and third layers.

16. The blow molded container of claim 1, wherein the extrusion blow-molding-capable grade of PET includes copolyester PET.

17. The blow molded container of claim 16, wherein the copolyester PET includes glycol-modified PET.

18. The blow molded container of claim 1, wherein the adhesive comprises at least one maleic anhydride-modified polyolefin.

19. The blow molded container of claim 1, the third layer further comprising additional adhesive.

20. The blow molded container of claim 19, wherein the third layer comprises from about 0.5% to about 10% by weight of additional adhesive, based on the weight of the regrind material.

21. The blow molded container of claim 19, wherein the third layer comprises from about 1% to about 5% by weight of additional adhesive, based on the weight of the regrind material.

22. The blow molded container of claim 19, wherein the adhesive and the additional adhesive have substantially the same composition.

23. The blow molded container of claim 1, the first layer further comprising at least one oxygen scavenger additive.

24. A blow molded container comprising a wall, said wall comprising:
a first layer comprising an extrusion blow-molding-capable grade of PET, said first layer being an inner surface layer of said wall;
a second, interior layer, said second layer comprising an oxygen scavenger additive; and
a third layer comprising an extrusion blow-molding-capable grade of PET, wherein said second layer is disposed between said first and third layers.

25. The blow molded container of claim 24, wherein:
said third layer is an outer surface layer of said wall.

26. The blow molded container of claim 24, wherein:
said first layer engages an inner side of said second layer; and
said third layer engages an outer side of said second layer.

27. The blow molded container of claim 26, wherein:
said third layer is an exterior surface layer of said wall.

28. The blow molded container of claim 26, wherein said first layer consists essentially of an extrusion blow-molding-capable grade of PET.

29. The blow molded container of claim 28, wherein said third layer consists essentially of an extrusion blow-molding-capable grade of PET.

30. The blow molded container of claim 29, wherein said second layer consists essentially of said adhesive material.

31. The blow molded container of claim 24, wherein said third layer consists essentially of regrind material from one or more containers having a composition similar to that of said blow molded container.

32. The blow molded container of claim 24, wherein said second layer consists essentially of a material selected from the group consisting of: polyamide resins and EVOH.

33. The blow molded container of claim 24, wherein:
said second layer comprises polyamide resin.

34. The blow molded container of claim 33, wherein said second layer consists essentially of polyamide resin.

35. The blow molded container of claim 34, wherein:
said first layer consists essentially of an extrusion blow-molding-capable grade of PET.

36. The blow molded container of claim 34, wherein:
said third layer consists essentially of an extrusion blow-molding-capable grade of PET.

37. The blow molded container of claim 36, wherein said third layer is an exterior layer of said wall.

38. The blow molded container of claim 24, wherein:
said second layer comprises EVOH.

39. The blow molded container of claim 38, wherein said second layer consists essentially of EVOH.

40. The blow molded container of claim 39, wherein:
said first layer consists essentially of an extrusion blow-molding-capable grade of PET.

41. The blow molded container of claim 40, wherein:
said third layer consists essentially of an extrusion blow-molding-capable grade of PET.

42. The blow molded container of claim 41, wherein said third layer is an exterior layer of said wall.

43. The blow molded container of claim 24, wherein said second layer comprises a material selected from a group consisting of: polyamide resin, EVOH, and cycloolefins.

44. The blow molded container of claim 43, wherein:
said second layer comprises at least one cycloolefin.

45. The blow molded container of claim 44, wherein said second layer consists essentially of at least one cycloolefin.

46. The blow molded container of claim 24, wherein:
said second layer comprises at least one unsaturated polyolefin.

47. The blow molded container of claim 46, wherein said second layer consists essentially of at least one unsaturated polyolefin.

48. The blow molded container of claim 24, wherein:
said blow molded container comprises a body portion that consists essentially of said first, second, and third layers.

49. The blow molded container of claim 1, wherein:
said first layer comprises about 2% to about 10% of the total weight of the container.

50. The blow molded container of claim 49, wherein:
said first layer comprises about 4% to about 10% of the total weight of the container.

51. The blow molded container of claim 49, wherein:
said first layer comprises about 5% of the total weight of the container.

52. The blow molded container of claim 1, wherein:
said second layer comprises about 0.5% to about 3% of the total weight of the container.

53. The blow molded container of claim 24, wherein:
said first layer comprises about 2% to about 10% of the total weight of the container.

54. The blow molded container of claim 53, wherein:
said first layer comprises about 4% to about 10% of the total weight of the container.

55. The blow molded container of claim 53, wherein:
said first layer comprises about 5% of the total weight of the container.

56. A blow molded container comprising:
a co-extruded, multi-layer, blow molded wall comprising at least one layer that comprises a blend of:
(A) an extrusion-blow-molding-capable grade of PET;
(B) at least one barrier material; and
(C) regrind from at least a particular multi-layer container, said particular multi-layer container comprising at least one layer of an extrusion-blow-molding-capable grade of PET.

57. The blow molded container of claim 56, wherein:
said co-extruded, multi-layer, blow molded wall is a first co-extruded, multi-layer, blow molded wall; and
said particular multi-layer container comprises a second co-extruded, multi-layer, blow molded wall.

58. The blow molded container of claim 57, wherein said barrier material is selected from a group consisting of: (A) polyamide resin; (B) EVOH; and (C) one or more PET-compatible oxygen scavengers.

59. The blow molded container of claim 58, wherein said regrind comprises regrind from a multilayer extrusion-blow-molding-capable grade of PET/EVOH/extrusion-blow-molding-capable grade of PET extrusion process.

60. The blow molded container of claim 59, wherein said barrier material comprises polyamide resin.

61. The blow molded container of claim 58, wherein said barrier material comprises EVOH.

62. The blow molded container of claim 58, wherein said barrier material comprises one or more PET-compatible oxygen scavengers.

63. A blow molded container comprising: a co-extruded wall comprising at least one barrier layer comprising a first portion of regrind material, said first portion of regrind material being regrind from a process of manufacturing particular blow molding containers, said particular blow molding containers comprising:
a first layer comprising a blow-molding-capable grade of PET and at least one oxygen scavenger additive, said first layer being an inner surface layer of said wall;
a second, interior layer, said second layer comprising adhesive; and
a third layer comprising a second portion of regrind material, said second portion of regrind material being regrind from one or more containers having a composition that is similar to that of said particular blow molded containers; wherein:
said second layer is disposed between said first and third layers and is adapted to bond said first layer to said third layer.

64. The blow molded container of claim 63, wherein said blow molded container consists essentially of said first portion of regrind material.

65. The blow molded container of claim 63, wherein said at least one barrier layer further comprises at least one virgin barrier resin.
